(19) United States
(12) Patent Application Publication
(10) Pub. No.: US 2014/0219556 A1
(43) Pub. Date: Aug. 7, 2014

(54) GENERALIZED ROBUST MULTICHANNEL FEATURE DETECTOR

(71) Applicants: Pavel Sergeevitch Smirnov, Saint-Petersburg (RU); Piotr Konstantinovitch Semenov, Saint-Petersburg (RU); Alexander Nikolayevich Redkin, Saint-Petersburg (RU); Dmitry Anatolievich Gusev, Saint-Petersburg (RU)

(72) Inventors: Pavel Sergeevitch Smirnov, Saint-Petersburg (RU); Piotr Konstantinovitch Semenov, Saint-Petersburg (RU); Alexander Nikolayevich Redkin, Saint-Petersburg (RU); Dmitry Anatolievich Gusev, Saint-Petersburg (RU)

(73) Assignee: Intel Corporation, Santa Clara, CA (US)

(21) Appl. No.: 13/976,399

(22) PCT Filed: Dec. 29, 2011
(86) PCT No.: PCT/RU2011/001040

§ 371 Date: Apr. 10, 2014

(51) Int. Cl. G06K 9/46

(52) U.S. Cl. CPC G06K 9/4652; G06K 2009/4657
USPC 382/165

(57) ABSTRACT

A method can include performing a local search for a local optimal color within a local neighborhood of a multichannel image, projecting the local neighborhood of the multichannel image to a single-channel basis, and applying a single-channel detector to this projected local neighborhood.

### TECHNICAL FIELD

The disclosed technology relates generally to circuits and systems and, more particularly, to devices and systems for computer vision, image feature detection, and image recognition applications and techniques.

### BACKGROUND

Mobile Augmented Reality (MAR) is an important technology for today's computers, smartphones, gaming consoles, and home entertainment systems. Some examples of applications that rely upon MAR include annotating scenes (e.g., virtual tourism), identifying objects (e.g., shopping) and recognizing gestures controlling video games or the television. The image recognition process usually involves: (1) identification of image features or interest points, and (2) comparison of these image features from a query or target image with those from a database of images. A successful MAR implementation typically requires that the key image features are reliably detected under a range of conditions including image scaling, rotation, shifting, and variations in intensity and image noise.

Examples of interest points and image features include the following: edges, blobs (e.g., image regions that have no inner structure), ridges (e.g., linearly continued blobs), scale-space blobs, corners, crosses, and junctions of regions, edges, and ridges. Current feature detectors use gray-value invariants or some photometric invariants based on emulating human vision or some color model, such as Gaussian or Kubelka-Munk, or other photometric approach. There are cases, where the “image” is a set of channels that is not representable as human “color” directly. For example, FIG. 1 shows gray-scale, color, and spectrozonal (with conditional channel-to-color mapping) images.

FIG. 2 is an example spectrozonal image of an Arizona forest fire from the Advanced Spaceborn Thermal Emission and Reflection Radiometer (ASTER) gallery of the Jet Propulsion Laboratory. In the example, the image on the left displays bands 3, 2, and 1 in RGB, displaying vegetation as red. The large dark area represents burned forest, and small smoke plumes can be seen at the edges where active fires are burning. The image on the right substitutes short-wave infrared (SWIR) band 8 for band 3. The bright red spots represent active fires, which are visible because the SWIR wavelength region has the capability of penetrating through the smoke.

Also in current systems, channels can be mapped not only to a microwave intensity channel but to a radar/lidar channel (e.g., Doppler frequency shift) or to an ultrasonic rangefinder channel or different Z-sensor type. For example, FIG. 3 illustrates an example of a Microsoft Kinect Z-sensor depth map. However, photometric approaches are not suitable for the types of channels discussed above because range and velocity value distributions are significantly different from distributions of visible spectral domain electromagnetic field power.

Current techniques, such as SURF and SIFT, for example, use transformation of multichannel (e.g., colored) input image to a single-channel (e.g., grayscale) input image as a necessary preliminary step, thus losing significant image information. While some current techniques attempt to use a color map of the image, such techniques fail to use the full image spectrum data by either transforming the image to a “special” single-channel representation at some intermediate step or trying to localize image features by some global scalar measure of significance.

### BRIEF DESCRIPTION OF THE DRAWINGS

Embodiments of the disclosed technology are illustrated by way of example, and not by way of limitation, in the drawings and in which like reference numerals refer to similar elements.

FIG. 1 shows gray-scale, color, and spectrozonal (with conditional channel-to-color mapping) images.

FIG. 2 is an example spectrozonal image of an Arizona forest fire from the Advanced Spaceborn Thermal Emission and Reflection Radiometer (ASTER) gallery of the Jet Propulsion Laboratory.

FIG. 3 illustrates an example of a Microsoft Kinect Z-sensor depth map.

FIG. 4 shows different representations of a single-channel image in which the colorizing of a grayscale image produces no additional information.

FIG. 5 illustrates an equivalent color space transformation in which colors are rotated by

$$\frac{11}{16} π$$

around the RGB-vector {5, −7, 3}.

FIG. 6 is an example of a Euler test in which grayscaling destroys image features.

FIG. 7 shows an example of a color-blind test.

FIG. 8 illustrates a determinant of a Hessian-based detector response for the color-blind test shown in FIG. 7.

FIG. 9 illustrates a weak-intensive blob in some channel located at a strong-intensive saddle point in another channel.

FIG. 10 illustrates the response of a current, i.e., existing, multichannel detector for different scales in which there is no response for the blob.

FIG. 11 illustrates the response of a single-channel detector for different scales in which a classical detector detects the blob at large scale.

FIG. 12 illustrates an example demonstrating how a multichannel detector can outperform a single-channel detector.

FIG. 13 illustrates a multichannel detector response on a blob at the saddle scene for different scales in which the blob at the saddle is recognized.

FIG. 14 illustrates a multichannel detector colorized response to a color-blind test for different scales.

FIG. 15 illustrates an example of ColorSIFT output for test images in which not all of the blobs are recognized and the color-blind test is not passed.

FIG. 16 illustrates an example of a color Harris detector output for test images in which the Euler test is not passed.

FIG. 17 illustrates an example of a boosted color Harris detector output for test images in which the Euler test is still not passed.

FIG. 18 illustrates an example of a system in which embodiments of the disclosed technology may be implemented.

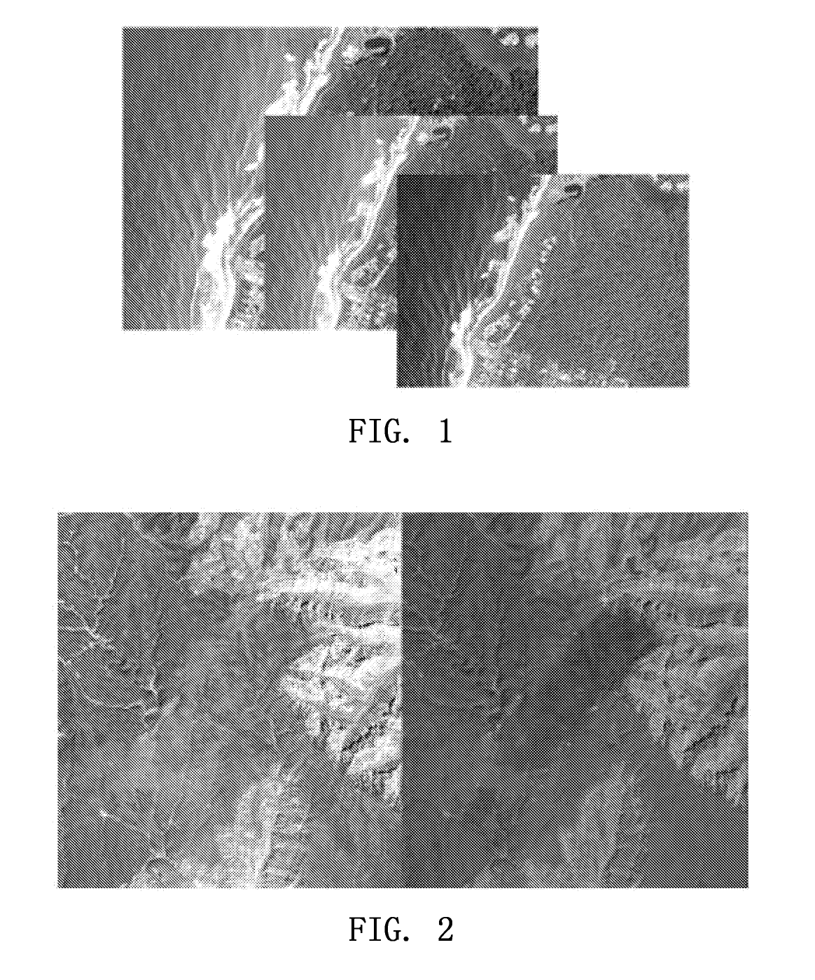

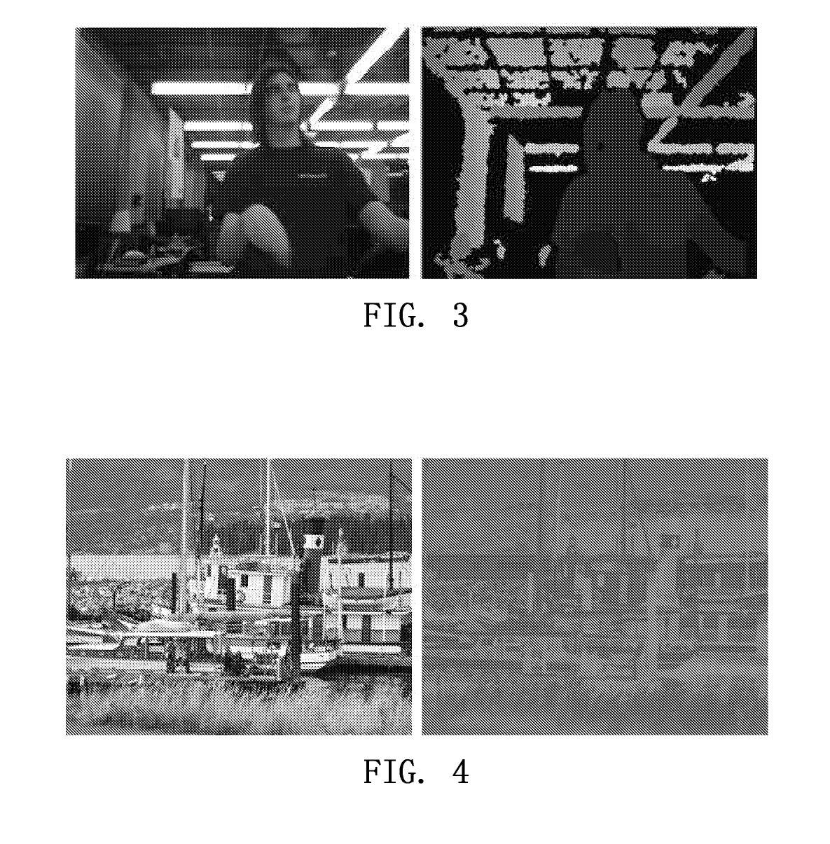

### DETAILED DESCRIPTION

A number of well-known computer vision algorithms for image feature detection use luminosity only or some specific color model. Although these methods may be effective in many cases, it can be shown that such transformations of the full image information reduce detection performance due to method-induced restrictions.

Embodiments of the disclosed technology include an implementation of a formal approach to the construction of a multichannel interest-point detector for an arbitrary number of channels, regardless of the nature of the data, which maximizes the benefits that may be achieved by using the information from these additional channels. Certain implementations may be referred to herein as a Generalized Robust Multichannel (GRoM) feature detector that is based upon the techniques described herein and include a set of illustrative examples to highlight its differentiation from existing methods.

By reducing a multichannel image into a single-channel image, one may obtain good results in natural images. However, there could be interest points hidden from such a detector due to its inherent color blindness. For example, current methods of combining color components tend to significantly lose information from the source after different scales and offsets of the channels in the image. Implementations of the disclosed technology avoid such drawbacks by identifying interest points in both spatial and spectral locations by utilizing information from all of the color components. This yields significantly better performance, especially in synergetic tests. For example, FIG. 6 (discussed below) shows a Euler-Venn diagram that is a test for detection of blob intersections. Such approaches can be used not only in three-channel visual images but also in larger dimensions and images from sources of arbitrary nature, e.g., depth maps, Doppler shifts, and population densities.

In addition to location of blob interest points, the techniques described herein can be extended for any number of types such as edges and ridges, for example. In such cases, the corresponding modification to the color subspace condition may be applied.

### Multichannel Interest-Point Detector Features

A. Common Requirements

This section will define common requirements for ideal generalized interest-point detectors and for multichannel detectors, particularly for the purpose of extending well-known single-channel detector algorithms.

1) Trivial Image

For a trivial image (e.g., constant image), where values of the image do not depend upon spatial coordinates, the set of interest points detected by the detector φ should be empty:

∀(x,y): I(x,y)=const [symbol] φ(I) ≡Ø

Trivial channels can be easily removed in the multichannel image as in the case of removing the unused (e.g., constant) α-channel in a αRGB image.

2) Contrast Invariance

Allowing a non-trivial image J to be the result of uniform scaling and offset transform of values of non-trivial image I:

∀c, k ≠0: J(x,y)=kI(x,y)+c

If the detector φ detects P interest points in the image I, then the same set should be detected in J:

∀c,k ≠0 [symbol] φ(I) ≡φ(c+kI)

3) Compatibility of Representations of Single-Channel Image

Allowing a multichannel image J={J₁, J₂, . . . , J_{N}} to be a map of non-trivial single-channel image from 1 to N channels, with its own uniform scaling and offset transformation for each channel, where there exists at least one non-trivial channel. For example, FIG. 4 shows different representations of a single-channel image in which the colorizing of a grayscale image produces no additional information.

The sets of interest points found by the single channel detector φ₁ in the image I and the multichannel detector φ_{N} in the multichannel image J, i.e., replication of image I, should be equivalent:

∀(i,x,y) ∃kᵢ≠0: Kᵢ(x,y) [symbol] φ₁ (I) ≡φ_{N}(J)

For a given image representation, similar detectors should produce the same result, without “ghost” detections in the equivalent multichannel image. White-box detector tests can allow one to check for such type weakness. The equivalence of single-channel and multichannel images from the perspective of feature detector allows one to reduce the number of linear-dependent channels.

4) Nonsingular Channel Transformation Invariance

Allowing an M-channels image J={J₁, J₂, . . . , J_{M}} to be a transformation of an N-channels image I={I₁, I₂, . . . , I_{N}} to the new channel (e.g., “color”) basis using channel conversion matrix K_{M,N}=(k_{i,j}) and channel offset vector c_{M}=(cᵢ):

$$∀ ( i = 1 … M , x , y ) \text{:} {J}_{1} ( x , y ) = {c}_{i} + {\sum }_{j = 1}^{N} {k}_{i , j} {I}_{j} ( x , y )$$

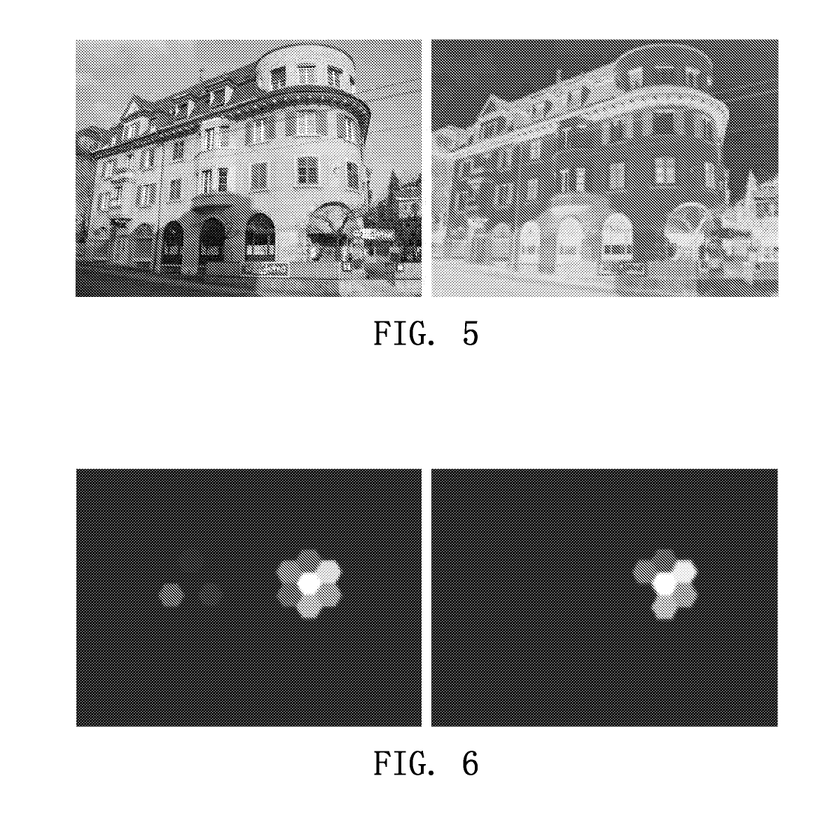

For example, FIG. 5 illustrates an equivalent color space transformation in which colors are rotated by

$$\frac{11}{16} π$$

around the RGB-vector {5, =7, 3}.

If rank(K_{M,N})=N and so transformation is invertible, then the sets of interest points detected in images I and J should be equivalent:

rank(K_{M,N})=N [symbol] φ_{N}(I) ≡φ_{M}(J)

If M >N then the image J has linear-dependent channels. For each image with linear-dependent channels, there exists a transformation that produces an image with linear-independent channels (e.g., reduction to the linear independent basis of channels). The assumption that the union of sets of interest points detected by the single-channel detector in all channels is a superset or equivalent to the set of points detected by multichannel detector is not true as illustrated by the following example.

FIG. 6 is an example of a Euler-Venn diagram in which grayscaling destroys image features. An edge detector can detect all edges in the given image. The union of all per-channel sets of edges is equivalent to the set of edges for the full-color detector. But per-channel detectors of blobs can find these interest points only in its “own” channel set and cannot find blobs in all intersections and unions of derivatives. Only a “synergetic” detector that uses information from the different channels can detect all such interest-points.

Though some color-basis transformation can map all subsets (e.g., base set, intersections, and unions) of this diagram to a new color basis, where each subset “color” is mapped to its own channel, the union of the sets of interest-points detected by single-channel detectors separately in every new channel is equivalent in this simple case to the whole multichannel interest points set.

5) Transformations to Reduced Basis

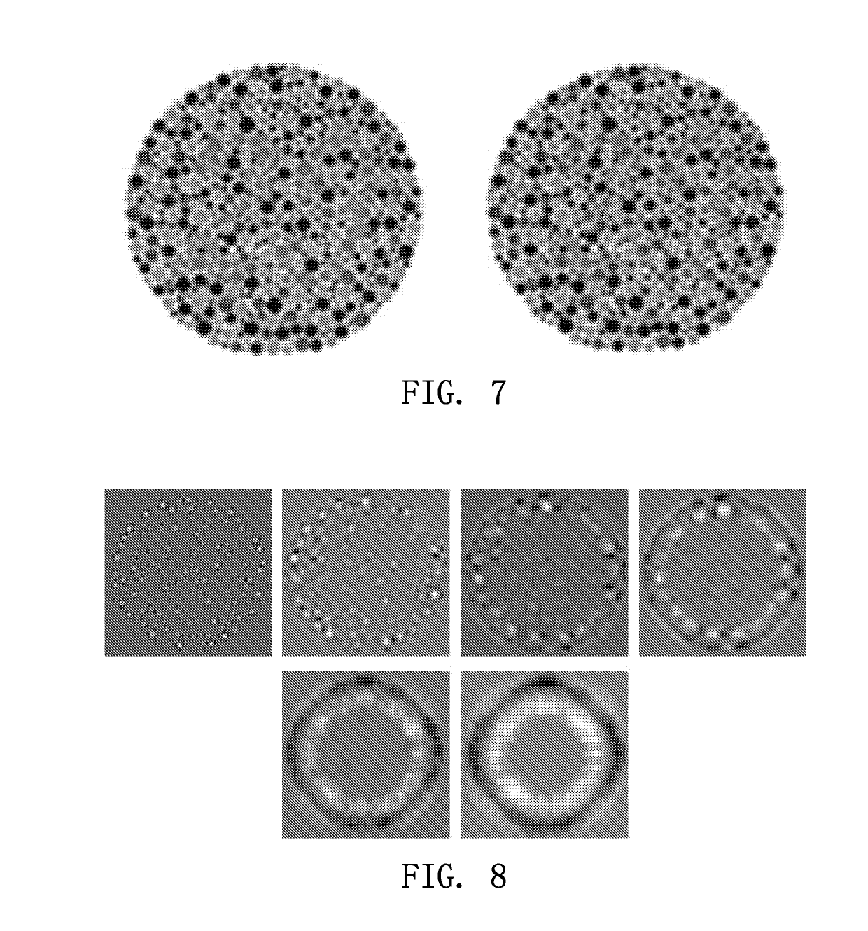

Transformation of channels with rank(K_{M,N}) <N is not equivalent to the initial image from point of view of detector. The initial image can have interest points that can be found in channels that are orthogonal to a new basis. This may be referred to as the “color blind” effect. FIG. 7 shows an example of a color-blind test and FIG. 8 illustrates a determinant of a Hessian-based detector response for the color-blind test shown in FIG. 7. FIG. 8 demonstrates that the color pattern is not recognized in grayscale.

6) Fragmentation Criteria

If an image is split into space-domain fragments, then the union of sets of detected interest points of fragments should be a subset of the set of detected interest points of the whole image.

Image fragments can use unique transformations of channels that emphasize interest point detection in comparison with the whole image. If an interest point is found in such an enhanced fragment, then this point should be found in the whole image too. Interest-point detector estimations (e.g., detection enhancements) should be local in space. For example, if a camera flash was used for some image, then contrast, brightness, and light spectrum would be different for short-range and long-range objects. Accordingly, global channel statistics would generally not be useful in this case.

B. Current Image Feature Detectors

Algorithms for interest-point detection typically apply convolution with space-domain filter kernels and then analyze the resulting responses as scalar values by calculating gradients, Laplacians, or finding local extrema values.

The mapping of color responses to scalar values for color images in detectors can have a variety of shortcomings as explained below. With regard to a color-blind test (see, e.g., FIGS. 7 and 8 above), a SIFT detector (e.g., using the Difference of Gaussians or the LoG approximation, Laplacian of Gaussian) and a SURF detector (e.g., using the Determinant of Hessian) use scalar values only. The color image is converted to grayscale before SIFT or SURF image processing. These algorithms cannot detect interest points in color-blind test images such as those shown in FIGS. 7 and 8.

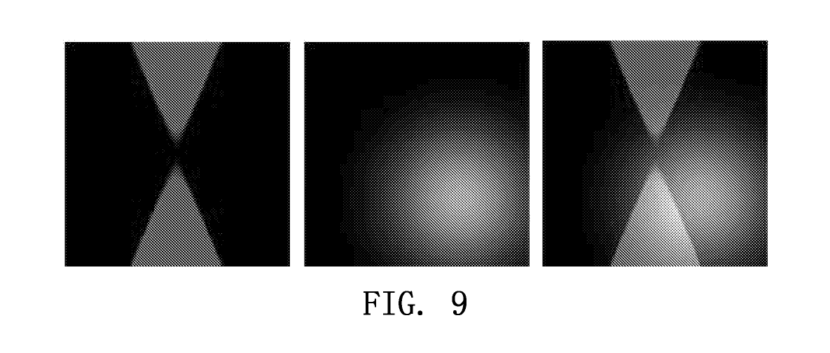

A multichannel detector based on the positivity rule for Hessian determinant values changes the product of scalars with a scalar product of vectors of values in channels. Due to the use of differential operators, this approach is invariant to constant components in signals from different channels. But it is not invariant to the range of values in the channels. To demonstrate the failure of this principle one can take a special color image, such as a weak-intensive blob in some channel located at a strong-intensive saddle point in another channel as shown in the example illustrated by FIG. 9. FIG. 9 shows a weak green blob and a strong asymmetric red saddle: two correlated image features. A current multichannel detector cannot recognize this feature (e.g., weak blob), but its single-channel analog can. For an RGB-example, a current detector results in the following:

$$( ( \begin{matrix}{L}_{x , x}^{R} \\ {L}_{x , x}^{C} \\ {L}_{x , x}^{B}\end{matrix} ) , ( \begin{matrix}{L}_{y , y}^{R} \\ {L}_{y , y}^{G} \\ {L}_{y , y}^{B}\end{matrix} ) ) - ( ( \begin{matrix}{L}_{x , y}^{R} \\ {L}_{x , y}^{G} \\ {L}_{x , y}^{B}\end{matrix} ) , ( \begin{matrix}{L}_{x , y}^{R} \\ {L}_{x , y}^{C} \\ {L}_{x , y}^{B}\end{matrix} ) ) = {\sum }_{1} ( {L}_{x , x}^{I} \cdot {L}_{y , y}^{I} - {L}_{x , y}^{I} \cdot {L}_{x , y}^{I} )$$

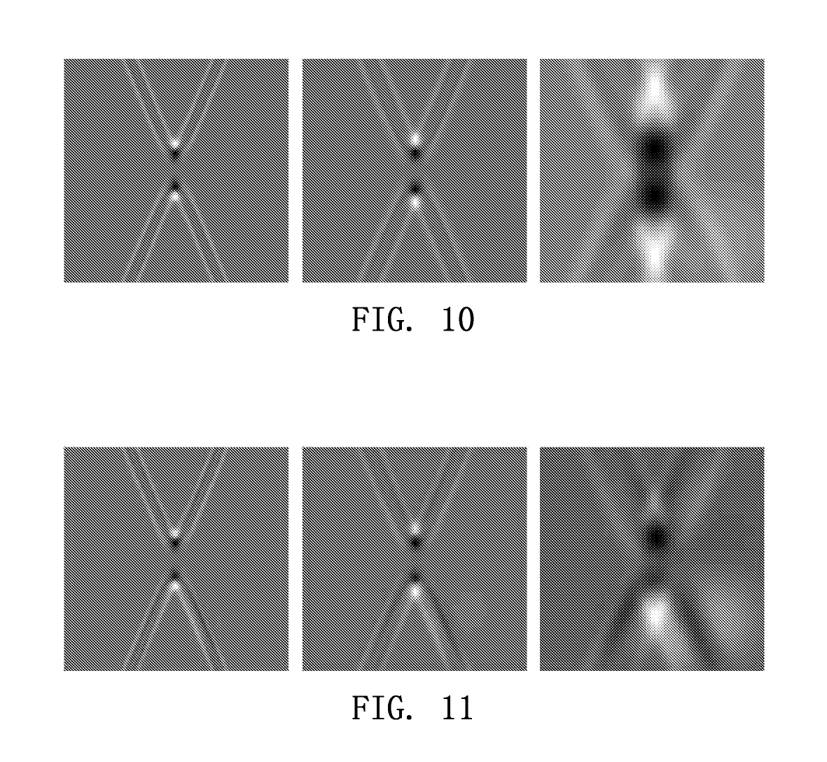

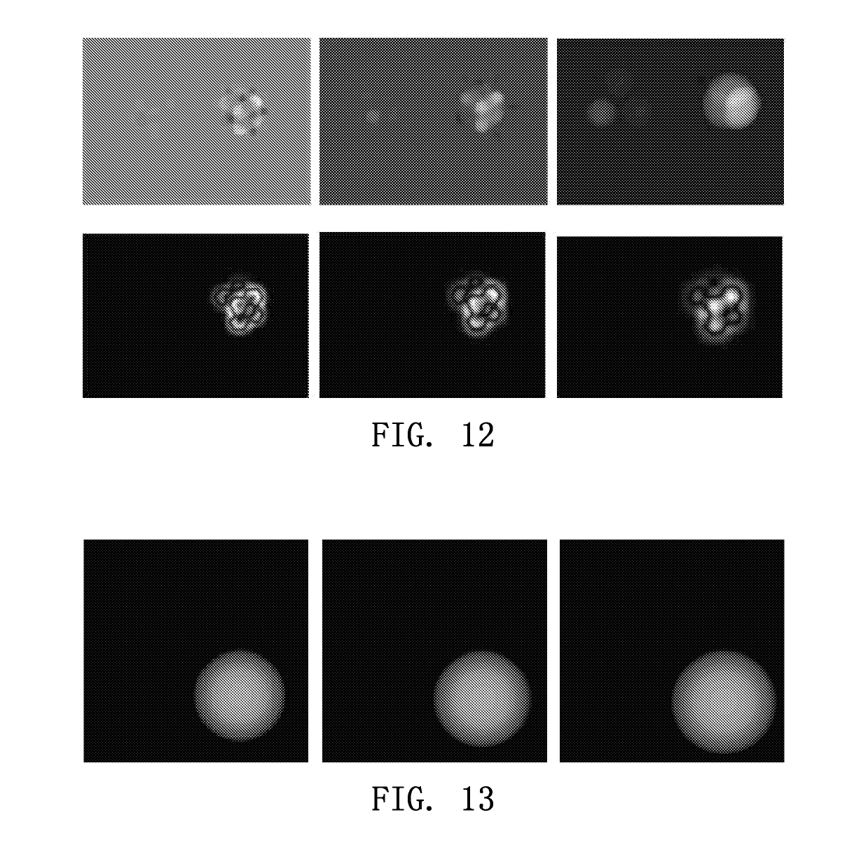

This expression has strong L_{x,y} components that correspond to a saddle point. They suppress weak positive values corresponding to the blob and the result is a negative value. But the Hessian determinant-based detector searches for positive values only. A classical intensity-based single-channel detector can recognize these features. For example, FIG. 10 illustrates the response of a current multichannel detector for different scales in which there is no response for the blob. FIG. 11 illustrates the response of a single-channel detector for different scales in which a classical detector detects the blob at large scale. Accordingly, this multichannel detector is not reliable.

Other current detectors calculate multichannel components of Hessians for each channel independently. In such an approach, the operations of convolution followed by the derivative of the Gaussian kernel are applied to the image. Due to the linearity of this operation it is equivalent to a linear combination of image channels. Consequently, the approach is potentially color blind. In other words, there exist images that may be degenerated in a constant area by this linear combination. Also, for these types of images there should be linear combinations that allow one to recognize lost features.

### GENERALIZED ROBUST MULTICHANNEL (GRoM) IMAGE FEATURE DETECTOR

Possible signal shifts require the use of differential detector methods. Signal scaling, possibly with inversion, restricts the use of absolute thresholds. The use of local extrema search is preferable. The test of a weak blob located at a strong saddle (see, e.g., FIG. 9 and related description above) demonstrates that there is no universal color model that enables one to distinguish such an interest point. Therefore, for each point of interest, a local search (e.g., in accordance with requirement 6) above) should be performed also in channel components in order to find the optimal “color” for the interest point. The multichannel detection task can be reduced to following tasks: search of “local optimal color” (e.g., exact solution of maximization problem), conversion of a local neighborhood from a multichannel image to a single-channel basis, and application of a single-channel detector in the local neighborhood.

“Color” refers to a vector that defines a projection of channel values to a single channel (e.g., conversion to gray-scale). The single-channel detector response function defines a method for optimal (or “differential” for approximate (sub-optimal) solution of search) selection of “color”. Calculating the Hessian matrix of channel values convolved with the Gaussian kernel that was converted to some “best blob color”, eigenvalues λ₁ and λ₂ of such Hessian matrix H for blob should be both positive (or both negative, as the direction sign is not significant) and a ratio of the eigenvalues difference to the eigenvalues sum (Tr(H)) should be as minimal as possible (e.g., most symmetrical blob). This ratio may be an equivalent of conic section eccentricity ε(e.g., compared with “blob roundness”

$$q = \frac{4 Det ( H )}{{Tr ( H )}^{2}} ) .$$

The eccentricity value E can help to classify the current point: blob (ε<1), ridge (ε=1) or saddle point (ε>1). The criteria of blob detection at this point is a local maximum of Laplacian (Tr(H)) of multichannel “color” projections to a selected “best color” vector. In certain embodiments, a GRoM-based algorithm for blob detector is shown as Algorithm 1 below, where the “best blob color” u is Laplacian which non-blob components are suppressed by eccentricity factor:

Algorithm 1—GRoM algorithm

1. Compute “local” differential color

1.1. Compute Hessian tensor at point (x₀,y₀):

$$H = ( \begin{matrix}{L}_{x , x} ( {x}_{0} , {y}_{0} ) & {L}_{x / y} ( {x}_{0} , {y}_{0} ) \\ {L}_{x , x} ( {x}_{0} , {y}_{0} ) & {L}_{x / y} ( {x}_{0} , {y}_{0} )\end{matrix} )$$

1.2. Compute “best blob color”:
u=(−sng(Lᵢ), Re {square root over (det Hᵢ))}ᵢ₌₀ⁿ⁻¹where Hᵢ and Lᵢ denotes correspondingly Hessian and Laplacian at some point (x, y) computed in i-th channel only.

2. Test for extreme point at (x₀, y₀) (as max projection to u):

∀(xᵢ,yᵢ) ε neighborhood of (x₀,y₀):

(u,L_{x,x}(X₀,y₀)+L_{y,y}(X₀,y₀)) >

(u,L_{x,x}(xᵢ,yᵢ)+L_{y,y}(xᵢ,yᵢ))

The capabilities of a Laplacian-based multichannel detector can be demonstrated in a synergetic test. The multichannel image has intersecting blobs in different channels. This intersection has created a new feature in the image. One could convert the image from RGB to grayscale: 30% of red, 59% of green, and 11% of blue, for example. As is apparent from the Euler-Venn diagram of FIG. 6, however, such a translation loses much information and the black color encodes 11% of the starting intensity. A multichannel detector is able to recognize more image features than a single-channel competitor as can be seen in FIG. 12, for example. This test shows that if a degenerated matrix of correspondence from the initial color space to the grayscale one is used, then the single-channel detector features will not be recognizable in the transformed image.

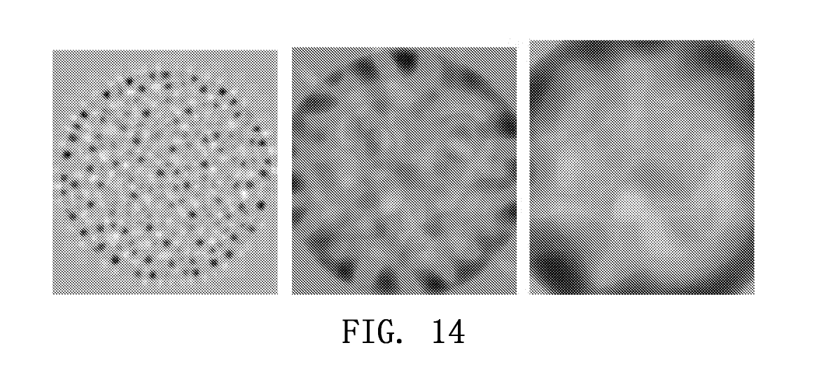

In contrast, embodiments of the disclosed technology may include a detector that is able to detect all interest points in the image of FIG. 6, for example, as well as the weak blob of FIG. 9 (see, e.g., FIG. 13). Such a detector also passes the color-blind test successfully (see, e.g., the detector responses illustrated by FIG. 14). A GRoM image feature detector as described herein is not “Yet Another Color Blob Detector” but, rather, a method for multichannel detector development. In certain embodiments, a GRoM image feature detector may use another “best color” search algorithm for maximization of the Harris-Stephens detector response R=Det(H)−k Tr(H), for example.

Certain classical approaches to image feature detector include defining an image feature as a triplet (x, y, σ), where x and y are spatial coordinates and σ is a scale. For this triplet, the feature located in (x, y) has a maximum value of significant measure among all points of its neighborhood Sσ(x, y). The significance measure “convolves” vector information about color into a scalar. Also, because this measure is global, it does not depend on the point (x, y). Certain embodiments of the disclosed technology may include defining an image feature as a quadruple (x, y, σ, v), where v is a “local” color of a feature located at point (x, y), v may be chosen to make a measure having a maximum at (x, y) in set Sσ,v(x, y) and a grayscale neighborhood Sσ,y(x, y) may be given when it projects colors of points from Sσ(x, y) onto v.

A classical color-less approach to the problem is to define an image feature as a point that dominates in its grayscale neighborhood by some scalar measure. Whereas recent attempts may try to define an image feature as a point that dominates in its colored neighborhood by the same scalar measure, embodiments of the disclosed technology may include defining an image feature as a point that dominates in its colored neighborhood, projected to its “local” grayscale plane in color space, by scalar measure. By defining the image feature in this manner, it becomes “natively” multichannel (e.g., colored), and the corresponding feature detector is able to use full image information and locate more image features than current detectors.

### SHORTCOMINGS OF CURRENT IMAGE FEATURE DETECTORS THAT ARE ADDRESSED BY THE DISCLOSED TECHNOLOGY

Unlike current color detectors such as the ColorSIFT and color Harris detectors, for example, a GRoM image feature detector in accordance with the disclosed technology works well with test images such as a weak-intensive blob at a strong-intensive saddle (see, e.g., FIG. 9), a Euler-Venn diagram (see, e.g., FIG. 6), and a color-blind test (see, e.g., FIG. 7), as discussed above.

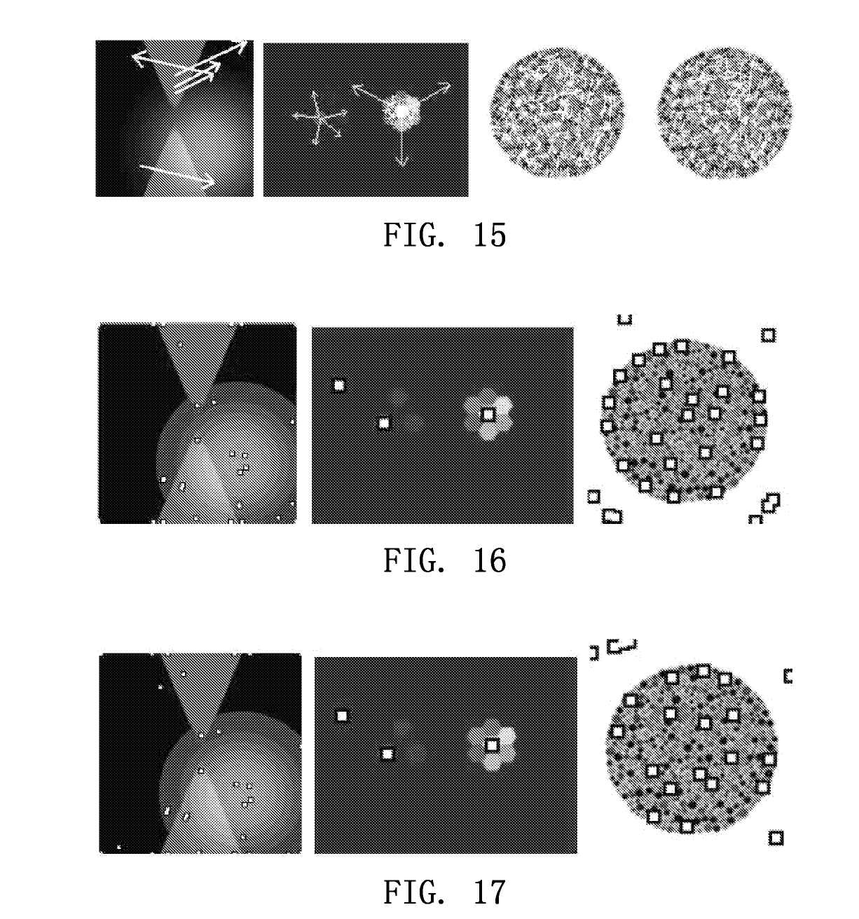

The ColorSIFT detector is a blob detector. FIG. 15, which uses ColorSIFT visualization notation for interest points, illustrates an example of ColorSIFT output for test images in which not all of the blobs are recognized and the color-blind test is not passed. Consequently, the ColorSIFT detector does not satisfy any of the test cases.

The color Harris detector is a corner detector. There are two versions of the color Harris detector: a classical one and a boosted one. FIG. 16 illustrates an example of a color Harris detector output for test images in which the Euler test is not passed. From FIG. 16, one can see that, while the detector may work well with saddle and color-blind tests because of blob corner detection, it does not work with the Euler-Venn diagram. A boosted color Harris detector has the same behavior/shortcomings, as can be seen in FIG. 17.

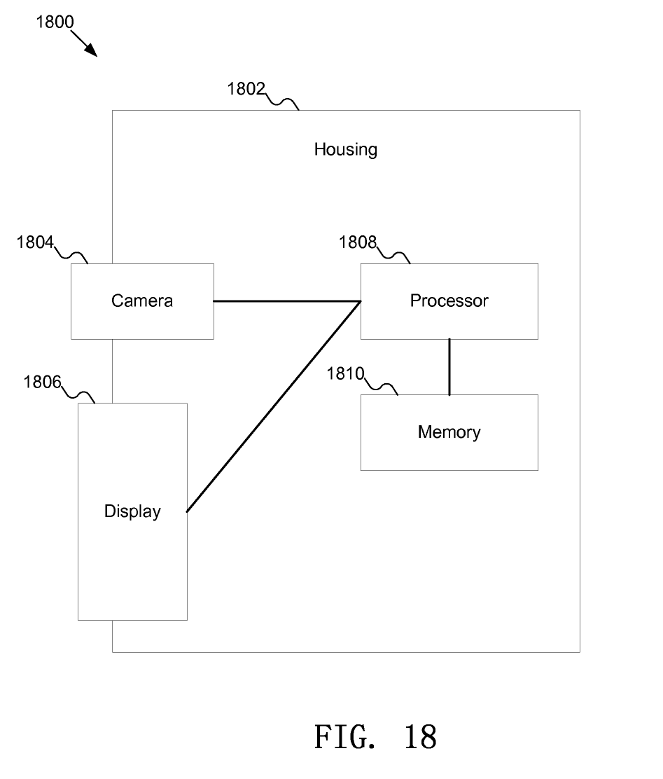

FIG. 18 illustrates an example of a system 1800 in which embodiments of the disclosed technology may be implemented. The system 1800 may include, but is not limited to, a computing device such as a laptop computer, a mobile device such as a handheld or tablet computer, or a communications device such as a smartphone. The system 1800 includes a housing 1802, a display 1804 in association with the housing 1802, a camera 1806 in association with the housing 1802, a processor 1808 within the housing 1802, and a memory 1810 within the housing 1802. The processor 1808 may include a video processor or other type of processor. The camera 1806 may provide an input image to be sent to the processor 1808. The memory 1810 may store an output image that results from processing performed on the input image by the processor 1808. The processor 1808 may perform virtually any combination of the various image processing operations described above.

The techniques described herein may be incorporated in various hardware architectures. For example, embodiments of the disclosed technology may be implemented as any of or a combination of the following: one or more microchips or integrated circuits interconnected using a motherboard, a graphics and/or video processor, a multicore processor, hardwired logic, software stored by a memory device and executed by a microprocessor, firmware, an application specific integrated circuit (ASIC), and/or a field programmable gate array (FPGA). The term “logic” as used herein may include, by way of example, software, hardware, or any combination thereof.

Although specific embodiments have been illustrated and described herein, it will be appreciated by those of ordinary skill in the art that a wide variety of alternate and/or equivalent implementations may be substituted for the specific embodiments shown and described without departing from the scope of the embodiments of the disclosed technology. This application is intended to cover any adaptations or variations of the embodiments illustrated and described herein. Therefore, it is manifestly intended that embodiments of the disclosed technology be limited only by the following claims and equivalents thereof.

1. A method, comprising:
performing a local search for a local optimal color within a local neighborhood of a multichannel image;
projecting the local neighborhood of the multichannel image to a single-channel basis; and
applying a single-channel detector to the projected local neighborhood.

2. The method of claim 1, wherein the local optimal color comprises a vector that defines a projection of channel values to a single channel.

3. The method of claim 1, wherein the performing comprises performing the local search for each of a plurality of points of interest in the multichannel image.

4. The method of claim 1, wherein performing the local search comprises computing a local differential color.

5. The method of claim 4, wherein computing the local differential color comprises computing a Hessian matrix H at point (x₀, y₀) using the following:
$$H = ( \begin{matrix}{L}_{x , x} ( {x}_{0} , {y}_{0} ) & {L}_{x , y} ( {x}_{0} , {y}_{0} ) \\ {L}_{x , x} ( {x}_{0} , {y}_{0} ) & {L}_{x , y} ( {x}_{0} , {y}_{0} )\end{matrix} )$$

6. The method of claim 5, wherein eigenvalues λ₁ and λ₂ of the Hessian matrix H are both positive.

7. The method of claim 5, wherein eigenvalues λ₁ and λ₂ of the Hessian matrix H are both negative.

8.-19. (canceled)

20. A method, comprising:
defining an image feature within an image as a quadruple (x, y, σ, v), wherein v is a local color of the image feature located at a point (x, y) that has a maximum of significant measure among each point of its colorized neighborhood Sσ,v(x, y); and
defining a grayscale neighborhood Sσ,v(x, y) based on how the grayscale neighborhood projects colors of points from Sσ(x, y) onto v.

21. A non-transitory computer-readable medium storing instructions that, when executed by a processor, cause the processor to:
define an image feature within an image as a quadruple (x, y, σ, v), wherein v is a local color of the image feature located at a point (x, y) that has a maximum of significant measure among each point of its colorized neighborhood Sσ,v(x, y); and
define a grayscale neighborhood Sσ,v(x, y) based on how the grayscale neighborhood projects colors of points from Sσ(x, y) onto v.

22. An apparatus, comprising:
an input port configured to receive an image; and
a video processor configured to:
define an image feature within the image as a quadruple (x, y, σ, v), wherein v is a local color of the image feature located at a point (x, y) that has a maximum of significant measure among each point of its colorized neighborhood Sσ,v(x, y); and
define a grayscale neighborhood Sσ,v(x, y) based on how the grayscale neighborhood projects colors of points from Sσ(x, y) onto v.

23. A portable computing device, comprising:
a housing;
a display in association with the housing;
a camera in association with the housing;
a memory within the housing; and
a processor within the housing configured to:
define an image feature within an image as a quadruple (x, y, σ, v), wherein v is a local color of the image feature located at a point (x, y) that has a maximum of significant measure among each point of its colorized neighborhood Sσ,v(x, y);
define a grayscale neighborhood Sσ,v(x, y) based on how the grayscale neighborhood projects colors of points from Sσ(x, y) onto v;
cause the display to visually present an output image resulting from the defining; and
cause the memory to store the output image.
